(19) United States
(12) Patent Application Publication
(10) Pub. No.: US 2008/0137898 A1
(43) Pub. Date: Jun. 12, 2008

(54) Audio enhanced decorative thermal insulating hand protector

(76) Inventor: Rochelle Nenner, Delray Beach, FL (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(21) Appl. No.: 11/635,974

(22) Filed: Dec. 8, 2006

(51) Int. Cl. H04R 1/00

(52) U.S. Cl. 381/385

(57) ABSTRACT

The invention is directed to audio enhanced thermal insulating hand protectors, such as decorative and non-decorative oven mitts or pot holders, which comprise a thermal insulating hand protector, audio playback circuitry integrated between internal layers of the thermal insulating hand protector, optional decorative theme-based design on the exterior of the hand protector, and theme-based audio playback segments that correspond to the optional decorative theme-based exterior of the hand protector. The theme may relate to any field of interest, such as birthdays, anniversaries, Valentine's Day, Christmas, etc.

In the preferred embodiment of the invention, the audio enhanced thermal insulated hand protector is a decorative oven mitt with audio playback segments that correspond to the visual decorative theme, and thereby enhance the experience of using thermal insulating hand protectors.

### FIELD OF THE INVENTION

In general, this invention relates to the field of thermal insulating hand protectors, such as oven mitts and pot holders, as well as the field of audio playback circuitry, and, more specifically, to a new combination of these fields of technology.

### BACKGROUND OF THE INVENTION

Thermally insulative hand protectors, such as potholders and over mitts used in the cooking arts, are well known. Principally, these products are purely functional, staple articles of commerce which do nothing more than provide a layer of insulation between the hand of a user and a heated cooking receptacle. Typically, such products are taken for granted, heavily worn and soiled, and do nothing more than simply act as a bland insulator.

No one has offered a novelty potholder or oven mitt which incorporates an audio playback circuit actuated upon use thereof. Using nothing more than a computer web browser and an Internet search engine, such as the search engine provided by Google, Inc, 1600 Amphitheatre Parkway, Mountain View, Calif. 94043, online shoppers entering the phrases “oven mitt” or “pot holder” can find links to Internet sites where such thermal insulating hand protectors are offered for sale online. Whether these thermal insulating hand protectors are basic and non-decorative in their design or decoratively designed thermal insulating hand protectors, their design and construction is widely known by those skilled in the art of making such thermal insulating hand protectors.

Similar linking of online shoppers to online sellers can be obtained via Internet search engines by entering the phrase “talking doll,” whereby links to Internet sites offering talking dolls and toys, complete with audio playback circuits embedded within such dolls and toys, can be found for sale online. Such audio playback circuits are varied in design and commonly known to those skilled in the art of such circuits.

However and regardless of whether the thermal insulating hand protector is basic and undecorated in nature or a decoratively designed version, no known thermal insulating hand protector exists where audio playback circuitry is integrated into a thermal insulating hand protector to play a pre-recorded message associated with a decorative theme of the protector. Manufacturers of oven mitts and pot holders produce a plethora of decoratively designed oven mitts and/or pot holders to celebrate the user's interest in a favorite holiday, sports team, culinary art, or other interest, yet the inventor is not aware of any over mitt or potholder which employs a theme-based outer covering with an audio playback circuit which plays a prerecorded message, which may or may not be associated with the theme of the covering, to enhance the experience of using the oven mitt or potholder. Oven mitts, pot holders and other varieties of thermal insulating hand protectors improved by such audio enhancement would be novel and arguably enjoy commercial success as a result of the combination.

A need exists, therefore, for combining both basic and decorative theme-based thermal insulating hand protector technology, including oven mitts and pot holders, with the technology of audio playback circuitry, whereby the overall experience of using either basic oven mitts and pot holders or decorative theme-based oven mitts and pot holders would be enhanced by supplementing the visual experience with a theme-corresponding audible experience as well.

### SUMMARY OF THE INVENTION

The present invention for enhancing the experience of using thermal insulating hand protectors with theme-based audio playback may employ a multitude of apparatus embodiments and methods of practicing the invention, for example:
1. In a first apparatus embodiment of the invention, a thermal insulating hand protector is combined with an audio playback circuit, integrated via placement of the circuit in between layers of material in the thermal insulating hand protector. The audio playback circuit includes at least one or more prerecorded audio messages and is activated, for example, when the thermal insulating hand protector is used to grasp a physical object, whereby the grasping of a physical object actuates a switch which causes the preprogrammed audio segment to playback and, conversely, the releasing of the physical object causes playback to cease. Alternatively, the audio playback circuit is activated by manually pressing the switch.
2. A second apparatus embodiment is derived from the first embodiment, wherein the thermal insulating hand protector employs a decorative covering layer (e.g. of fabric) having a decorative theme that corresponds with the audible message (e.g. a holding theme.).
3. A third apparatus embodiment is derived from the first embodiment, wherein the thermal insulating hand protector is an oven mitt.
4. A fourth apparatus embodiment is derived from the second embodiment, wherein the thermal insulating hand protector is a decorative oven mitt enhanced with an audio message that corresponds with the decorative theme of the oven mitt.
5. A fifth apparatus embodiment is derived from the first embodiment, wherein the thermal insulating hand protector is a pot holder.
6. A sixth apparatus embodiment is derived from the second embodiment, wherein the thermal insulating hand protector is a decorative pot holder enhanced with an audio message that corresponds with the decorative theme of the pot holder.
7. In a first method of practicing the invention, a method for enhancing the experience of using thermal insulating hand protectors with audio playback of prerecorded sound comprises the steps of:
   a. providing a thermal insulating hand protector equipped with an integrated audio playback circuit embedded between layers of the thermal insulating hand protector, wherein the audio playback circuit is activated by closing a pressure or heat sensitive switch in the playback circuit;
   b. causing activation of the integrated audio playback circuit to playback one or more prerecorded audio segments upon the grasping of a physical object, such as a pot or colander, by a hand which is at least partially covered by the hand protector, wherein the pressure or heat associated with grasping the physical object causes the pressure or heat sensitive switch to close, such that the audio playback is caused to commence through a speaker in the audio playback circuit; and
   c. causing the integrated audio playback circuit to become deactivated by releasing the grasp on the physical object, whereby the removal of pressure or heat on the pressure or heat sensitive switch caused by releasing the grasped physical object causes the pressure or heat sensitive switch to open, whereby audio playback is caused to cease.
8. A second method for enhancing the experience of using thermal insulating hand protectors with audio playback of prerecorded sound comprises the steps of the first method, wherein the thermal insulating hand protector includes a decorative covering over at least a portion of the thermal insulating hand protector that corresponds with the theme of the audio message(s).
9. A third method for enhancing the experience of using thermal insulating hand protectors with audio playback of prerecorded sound comprises the steps of the first method, wherein the thermal insulating hand protector is an oven mitt.
10. A fifth method for enhancing the experience of using thermal insulating hand protectors with audio playback of prerecorded sound comprises the steps of the first method, wherein the thermal insulating hand protector is a pot holder.

### BRIEF DESCRIPTION OF THE DRAWINGS

FIG. 1 is a top view of an oven mitt, the preferred embodiment of this invention, wherein the layers of oven mitt material have been depicted as being cut and partially peeled back to reveal the audio playback circuitry inserted in between the decorative and insulating layers of the oven mitt material. Although not shown in any drawing herein, an alternative embodiment of the invention may include audio playback circuitry similarly inserted in between the decorative and insulating layers of the pot holder's material.

FIG. 2 is a block diagram of the audio playback circuitry, such circuitry being illustrative of, and not at all exhaustive of, audio playback circuits known to those skilled in the art, any of which, when combined with thermal insulating hand protectors, fall within the scope of the present invention.

### DETAILED DESCRIPTION

In a preferred embodiment, the invention is directed to combining a decorative theme-based thermal hand protecting oven mitt with an integrated audio playback circuit containing one or more prerecorded audio messages. Circuit integration is achieved, in the preferred embodiment, by imbedding the circuit between any of the various layers of oven mitt material. Both the decorative theme based oven mitt and corresponding prerecorded audio segments may relate to any theme of interest, such as birthdays, anniversaries, Valentine's Day, Christmas, favorite professional sports team, favorite culinary art, etc., enhancing the visual experience with an audio experience of the same or some other theme.

It is to be understood that the invention may employ any one or more of the audio playback circuit configurations known to those skilled in the art of audio playback circuits. A thermal insulating hand protector contemplated by this invention may include a power source, including at least one or more batteries, such as button cell batteries, an audio playback circuit, including memory, processor and audio amplifier circuitry, a speaker connected to the audio playback circuit, e.g., a 4 mm Mylar speaker, and a switch connecting the power source to the audio playback circuit, e.g., a grommet pushbutton switch connected to the audio playback circuit. Alternatively, the audio playback circuit may be created using any other combination of applicable circuit elements and devices know to those skilled in the art.

The preferred embodiment of the invention is also directed to a process for enhancing the visual and aural experience of cooking by employing a decorative theme-based thermal insulating hand protector with a corresponding audio message utilizing one or more prerecorded or custom recorded audio messages. The general steps are:
1. providing a thermal insulating hand protector equipped with an integrated audio playback circuit embedded between layers of the thermal insulating hand protector material, wherein the audio playback circuit is capable of activation by closing a mechanical, pressure, heat sensitive, etc. switch in the playback circuit;
2. causing the integrated audio playback circuit to playback one or more prerecorded audio messages when the switch is actuated, i.e. the switch is manually actuated (e.g. depressed) or the hand protector is used to grasp a physical object, such as a pot or colander such that the pressure or heat gain caused by grasping the physical object causes the pressure or heat sensitive switch to close, whereby audio playback is caused to commence through a speaker in the audio playback circuit; and
3. causing the integrated audio playback circuit to be disabled when either the complete message has been played, or the grasp on or heat associated with the physical object is released, whereby the release of pressure or heat on the switch caused by releasing the physical object causes the switch to open, such that audio playback is caused to cease.

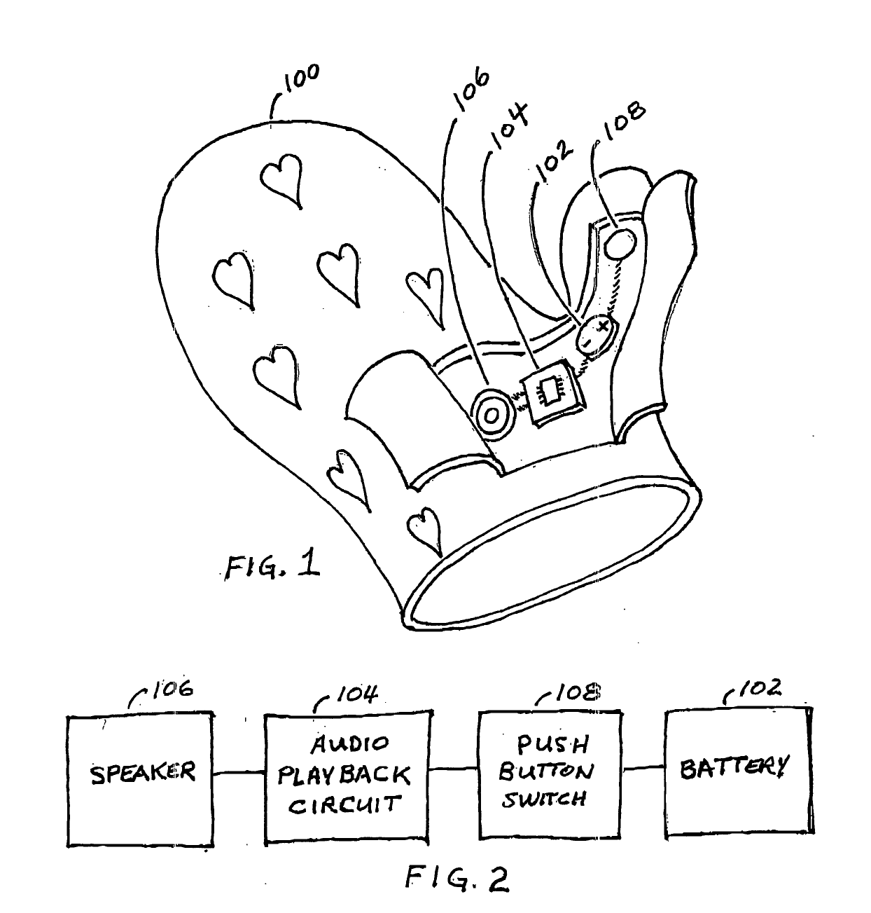

FIG. 1 is a palm-side-up illustration of the preferred embodiment of a thermal protector, e.g., a decorative theme-based oven mitt 100 shown with a Valentines Day theme design, wherein one of the layers (i.e. the outermost layer) of oven mitt material has been depicted as being cut and partially peeled back to reveal the audio playback circuitry 104 inserted in between the decorative 110 and insulating layers 112 of the oven mitt material. The audio playback circuit shown is illustrative of one of the numerous alternative audio playback circuit configurations known to those skilled in the art of such circuits, and/or which are suitable for implementation in this invention, all of which are contemplated by the Inventor as possible alternative audio playback circuit elements of the inventive combination of elements. However, in this preferred embodiment example, the audio playback circuitry shown in FIG. 1 includes a power source 102, comprising a battery, such as one or more button cell batteries, an audio playback circuit 104 which includes memory storage circuitry for storing at least one or more prerecorded audio segments, a processor and audio amplifier circuitry, a speaker 106 (e.g., 4 mm Mylar speaker) connected to the audio playback circuit; a pressure sensitive switch 108 (e.g., grommet pushbutton switch on wire leads) connecting the power source to the audio playback circuit. Although not shown in any drawing herein, the inventor conceives that an alternative embodiment of the invention includes audio playback circuitry similarly inserted in between some other layers (not shown) of an oven mitt or pot holder's material. Alternatively, the audio playback circuitry can also be inserted in between any of a multiple of insulating layers of a thermal protector's material, including thermal and fluid barrier insulating layers (not shown).

It is also to be understood that the audio playback circuit may be associated with, or placed under, any of the various layers on the back, side, etc. (as opposed to the palm-side) of the thermal protector, such as an oven mitt or pot holder. Further alternatively, any one or more of the components of the audio playback may be located anywhere on the oven mitt or pot holder. For example, the power source 102 and audio playback circuit 104 and speaker 106 may be associated with the back side of the thermal protector, while the switch 108 may be associated with the palm-side thereof. Multiple variations on placement of the various components of the audio playback circuitry will occur to those of skill in the art.

FIG. 2 is a block diagram of the one possible audio playback circuit configuration provided in FIG. 1, such circuitry being illustrative of, and not at all exhaustive of, audio playback circuits known to those skilled in the art and/or suitable for use with the invention.

It is also contemplated that switch 108 may be a heat sensitive switch, such that upon encountering a predetermined magnitude of temperature, such as when the hand protector 100 is used to grasp a hot cooking implement, the audio playback circuit will be closed, causing the audio message to be played through speaker 106.

IAs stated previously, it is also contemplated that the audio playback circuit may be positioned anywhere else on the hand protector, such as near the palm, near the wrist, or on or near any of the other fingers of the oven mitt, or anywhere on a hand protector of the “pot holder” variety, such as a simple rectangular internally insulative mat. Moreover, the switch 108 may be located on the inside of the oven mitt 100, on the rear side external to oven mitt 100, or on the palm side of oven mitt 100 shown in FIG. 1, with the remainder of the circuit embedded between any of the various layers of material of the hand protector. In this way, the switch can be manually manipulated without donning the oven mitt or a potholder type hand protector to grasp a cooking implement.

In all cases it is to be understood that the above described configurations are merely illustrative of the many possible specific embodiments which represent applications of the present invention. Numerous and varied other configurations can be readily devised in accordance with the principles of the present invention without departing from the spirit and scope of this invention.

What I claim is:

1. A thermal insulating hand protector with integrated audio playback circuit, which comprises:
a. an audio playback circuit, comprising at least one or more prerecorded audio segments; and
b. a thermal insulating hand protector, wherein the playback circuit is integrated between layers of material in the thermal insulating hand protector and the audio playback circuit is activated whenever the thermal insulating hand protector is used to grasp physical object, whereby the grasping of the physical object causes the one or more prerecorded audio segments to playback, and the releasing of physical object causes playback to cease.

2. The thermal insulating hand protector with integrated audio playback circuit as set forth in claim 1, wherein the hand protector includes a layer of decorative material which at least partially covers the hand protector and which decorative corresponds with the theme of the at least one or more prerecorded audio segments.

3. The thermal insulating hand protector with integrated audio playback circuit as set forth in claim 1, wherein the hand protector is an oven mitt.

4. The thermal insulating hand protector with integrated audio playback circuit as set forth in claim 2, wherein the hand protector is a decorative oven mitt having a layer of decorative material which at least partially covers the hand protector which corresponds with the theme of the at least one or more prerecorded audio segments.

5. The thermal insulating hand protector with integrated audio playback circuit as set forth in claim 1, wherein the hand protector is a pot holder.

6. The thermal insulating hand protector includes a layer of decorative material which at least partially covers the hand protector and which corresponds with the theme of the one or more prerecorded audio segments with integrated audio playback circuit as set forth in claim 2, wherein the hand protector with the theme of the at least one or more prerecorded audio segments.

7. A method for enhancing the experience of using a thermal insulating hand protector with audio playback of prerecorded sound, comprising the steps of:
a. providing a thermal insulating hand protector oven mitt equipped with an integrated audio playback circuit embedded between layers of the hand protector oven mitt material, wherein the audio playback circuit is capable of activation by closing a pressure sensitive switch in the playback circuit;
b. Causing activation of the integrated audio playback circuit to play one or more prerecorded audio segments upon grasping of a physical object, with the thermal insulating hand protector, wherein pressure created by grasping the physical object causes the pressure sensitive switch to close, whereby audio playback is caused to commence through a speaker in the audio playback circuit; and
c. causing deactivation of the integrated audio playback circuit upon releasing the grasp on the physical object, whereby the release of pressure on the pressure sensitive switch caused by releasing the physical object causes the pressure sensitive switch to open, whereby audio playback is caused to cease.

8. A method for enhancing the experience of using a thermal insulating hand protector with audio playback of prerecorded sound as set forth in claim 7, wherein the thermal insulating hand protector includes a decorative cover portion having a theme which corresponds with the theme of the one or more prerecorded sounds.

9. A method for enhancing the experience of using thermal insulating hand protectors with audio playback of prerecorded sound as set forth in claim 7, wherein the thermal insulating hand protector is an oven mitt.

10. A method for enhancing the experience of using thermal insulating hand protectors with audio playback of prerecorded sound as set forth in claim 8, wherein the thermal insulating hand protector includes a decorative cover portion having a theme which corresponds with the theme of the one or more prerecorded sounds.

11. A method for enhancing the experience of using thermal insulating hand protectors with audio playback of prerecorded sound as set forth in claim 7, wherein the thermal insulating hand protector is a pot holder.

12. A method for enhancing the experience of using thermal insulating hand protectors with audio playback of prerecorded sound as set forth in claim 8, wherein the thermal insulating hand protector includes a decorative layer having a theme which corresponds to the theme of the one or more prerecorded audio messages.
